(19) United States
(12) Patent Application Publication
(10) Pub. No.: US 2018/0159720 A1
(43) Pub. Date: Jun. 7, 2018

(54) DYNAMIC AGENT DEPLOYMENT IN A DATA PROCESSING SYSTEM

(71) Applicant: CA, INC., New York, NY (US)

(72) Inventor: APURV RAJ, Hyderabad (IN)

(73) Assignee: CA, INC., New York, NY (US)

(21) Appl. No.: 15/369,540

(22) Filed: Dec. 5, 2016

(51) Int. Cl. H04L 12/24; H04L 29/08

(52) U.S. Cl. CPC H04L 41/046; H04L 67/10

(57) ABSTRACT

A method of selecting an agent node for deploying an agent includes identifying a plurality of computing nodes in a distributed computing network that are configured to execute computing jobs, selecting an agent node from among a plurality of agent nodes for deploying an agent within the distributed computing network, wherein the agent controls processing of the computing jobs on at least one of the plurality of computing nodes, and wherein the agent node is selected in response to an anticipated workload on the computing nodes and network path lengths of the agent nodes to the computing nodes, and deploying the agent onto the selected agent node to control processing of at least one the computing jobs on the plurality of computing nodes.

### BACKGROUND

The present disclosure relates to data processing systems, and in particular, to the scheduling of jobs in data processing systems.

Data processing systems utilize scheduling engines to schedule execution of computer processes, or “jobs.” Scheduling the execution of computer processes is often referred to as job management, which may involve scheduling a computer process to occur at one designated time, repeatedly at periodic times, or according to other time schedules. Numerous scheduling engines exist today, such as Unicenter CA-7, Unicenter CA-Scheduler, and Unicenter CA-Job track available from Computer Associates.

In a distributed computing environment that includes many different data processing devices, such as a multi-server cluster, job scheduling is an important task. Distributed computing environment typically include software that allocates computing tasks across a group of computing devices, enabling large workloads to be processed in parallel.

Cloud computing/storage environments have become a popular choice for implementing data processing systems. In a cloud computing/storage environment, a cloud provider hosts hardware and related items and provides systems and computational power as a service to a customer, such as a business organization.

Cloud computing/storage environments may support virtual machines (VM), which are emulations of physical machines implemented in software, hardware, or combination of both software and hardware. In a cloud computing environment, jobs may be delegated to virtual machines. Virtual machine resources may be scheduled in a similar manner as physical machine resources. Thus, a distributed computing environment may include a number of network nodes that include physical machines, virtual machines, or a collection of both physical and virtual machines.

Entities to which tasks, or jobs, are assigned by a scheduler are generally referred to as “agents,” computing node and may reside on physical machines and/or virtual machines. An agent can execute jobs locally (i.e., on the same computing node on which the agent is hosted) or remotely (i.e., on a different computing node on which the agent is hosted). Network nodes that can host agents are referred to as “agent nodes.” Network nodes that can execute jobs on behalf of an agent are referred to herein as “computing nodes.” A network node can be both a computing node and an agent node. That is, a network node can both host an agent and execute jobs on behalf of an agent.

### SUMMARY

Some embodiments provide methods of selecting agent nodes for deploying agents. The methods may be performed on a computing device. A method according to some embodiments includes identifying a plurality of computing nodes in a distributed computing network that are configured to execute computing jobs, selecting an agent node from among a plurality of agent nodes for deploying an agent within the distributed computing network, wherein the agent controls processing of the computing jobs on at least one of the plurality of computing nodes, and wherein the agent node is selected in response to an anticipated workload on the computing nodes and network path lengths of the agent nodes to the computing nodes, and deploying the agent onto the selected agent node to control processing of at least one the computing jobs on the plurality of computing nodes.

Selecting the agent node may include selecting an agent node that maximizes a value function.

The value function may take into account network path lengths between the agent nodes and the computing nodes and the number of computing jobs to be executed at the computing nodes.

The value function may include: VF=Σ(Wm)(Sma)(Dma), where Wm is the workload at an mth computing node, Dma is a scale factor that depends on a network path length between the mth computing node and an ath agent node, and Sma is a scale factor indicating that an agent deployed on the ath agent node is executing computing jobs on the mth computing node.

The network path length may be based on a number of network hops through intervening network forwarding nodes between the mth computing node and the ath agent node and/or a communication latency between the mth computing node and the ath agent node.

The value of Dma may be equal to one if the ath agent node is the agent node closest to the mth computing node based on the network path length between the mth computing node and the ath agent node, and may be equal to zero if the ath agent node is not the agent node closest to the mth computing node based on the network path length between the mth computing node and the ath agent node.

The value of Sma may be equal to one if the ath agent node is executing computing jobs on the mth computing node, and may be equal to zero if the ath agent node is not executing computing jobs on the mth computing node.

The workload at the mth computing node, Wm, may corresponds to a number of computing jobs to be executed on the mth computing node.

The value of Dma may be equal to an average network path length from all agent nodes to the mth computing node divided by a network path length from the ath agent node to the mth computing node.

The method may further include relocating the agent from the selected agent node to a second agent node in response to changes in workloads on the first and second computing nodes and network path lengths of the selected agent node and the second agent node to the first and second computing nodes.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter, and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2 is a block diagram of a workload scheduling computer according to some embodiments of the inventive concepts.

FIG. 3 is a block diagram illustrating a network environment in which agents can be deployed according to embodiments of the inventive concepts.

FIG. 4 is a flowchart illustrating operations of systems/methods in accordance with some embodiments of the inventive concepts.

FIG. 5 is a block diagram illustrating an example deployment of an agent according to embodiments of the inventive concepts.

FIG. 6 is a block diagram of a computing system which can be configured as a workload scheduling computer according to some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As discussed above, in a distributed computing environment, an agent, or scheduler, may assign various tasks to one or more computing nodes. Computing nodes, whether they are implemented in physical or virtual machines, have a finite capacity for handling assigned workloads based on the amount of resources, such as processor capacity, memory, bandwidth, etc., available to the computing node. Moreover, the resources available to a virtual server may change dynamically, as the resources may be shared by other virtual machines hosted on the same physical server as the agent.

Conventionally, if a scheduler assigns a job to a computing node and the computing node does not have capacity to perform the job, either the job will be queued until the computing node has capacity or the workload agent will return an error in response to the assignment. In either case, execution of the job is delayed, and the scheduler may incur additional overhead associated with the job.

Some embodiments described herein are based on the realization that, in many network environments in which an agent may be deployed, the efficiency with which the agent can schedule and manage the performance of jobs by computing nodes may be affected by the proximity within the network of the agent to the computing nodes that are being managed by the agent. In this context, “deploy” means that an agent is installed and activated on a computing node. By way of non-limiting example, an agent may be deployed by moving the agent from an existing node to a new node, by installing a new agent onto a new or existing node, or by activating a previously installed agent on an existing node. Accordingly, embodiments of the inventive concepts provide systems/methods that dynamically deploy agents at locations within a network that enhances the efficiency with which the agents can schedule jobs for execution on servers.

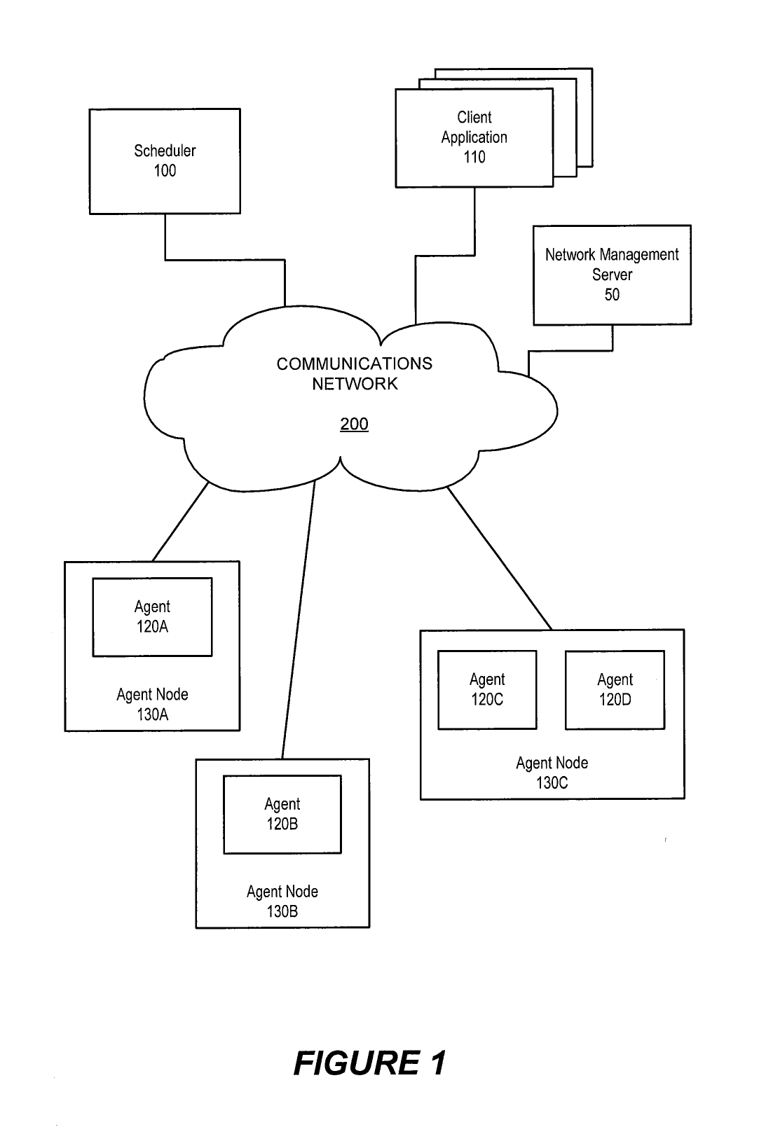

FIG. 1 is a block diagram of a distributed data processing network in which systems/methods according to embodiments of the inventive concepts may be employed. Referring to FIG. 1, a plurality of agent nodes 130A-130D are provided. The agent nodes 130A-130D may be generally referred to as agent nodes 130. The agent nodes 130 may be physical devices, such as servers that have processors and associated resources, such as memory, storage, communication interfaces, etc., or virtual machines that have virtual resources assigned by a virtual hypervisor. The agent nodes communicate over a communications network 200, which may be a private network, such as a local area network (LAN) or wide area network (WAN), or a public network, such as the Internet. The communications network 200 may use a communications protocol, such as TCP/IP, in which each network node is assigned a unique network address, or IP address.

One or more of the agent nodes 130 may host one or more agents 120, which are software applications configured to control execution of jobs assigned by a scheduler 100. In the distributed computing environment illustrated in FIG. 1, jobs are requested by client applications 110. A job request may be sent by a client application 110 to the scheduler 100. The scheduler 100 in turn distributes the job to one of the available agents 120 based on one or more parameters.

An agent 120, such as agent 120A, may receive a job assignment from the scheduler 100, cause the job to be executed, and return a result of the job to the scheduler 100, or alternatively to the client application 110 that requested the job. In other embodiments, the client application 110 may submit the job to a job manager (not shown), that may split the job into a plurality of sub-tasks, and request the scheduler 100 to assign each of the individual sub-tasks to one or more agents 120 for completion.

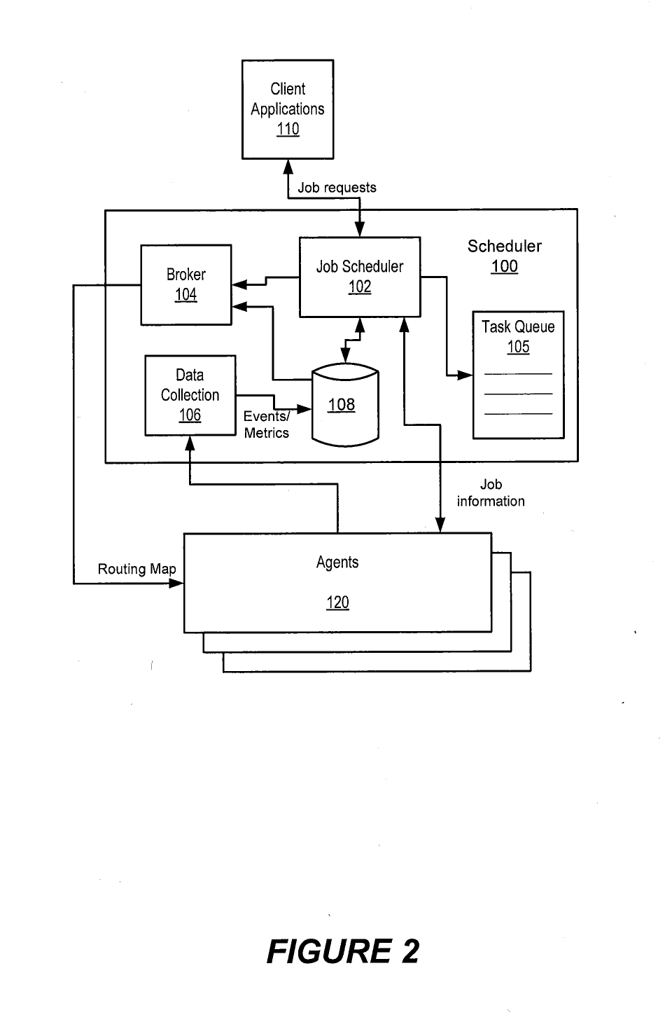

FIG. 2 is a block diagram of a scheduler 100 according to some embodiments showing components of the scheduler 100 in more detail. The scheduler 100 includes various modules that communicate with one another to perform the workload scheduling function. For example, the scheduler 100 includes a job scheduler module 102, a task queue 105, a database 108, a broker module 104, and a data collection module 106. It will be appreciated that the scheduler 100 may be implemented on a single physical or virtual machine, or its functionality may be distributed over multiple physical or virtual machines. Moreover, the database 108 may be located in the scheduler 100 or may be accessible to the scheduler 100 over a communication interface.

Client applications 110 submit job requests to the scheduler 100. The job requests are forwarded to the job scheduler module 102 for processing. The job scheduler module 102 uses the task queue to keep track of the assignment and status of jobs. The scheduler 100 transmits job information to agents 120 for processing, and may also store information about jobs in the database 108.

Information about the status of computing nodes, such as the available workload capacity of computing nodes, is collected by the broker module 104 and stored in the database 108, which is accessible to both the job scheduler 102 and the broker module 104. The data collection module 106 may collect information about events relating to jobs and metrics provided by agents and stores such information in the database 108. The job-related events may include job status information (queued, pending, processing, completed, etc.) and/or information about the agents, such as whether an agent is available for scheduling, is being taken offline, etc.

According to some embodiments, the broker module 104 provides routing map information directly to the agents 120. The routing map information may be provided along with job information or independent from job information to allow a computing node to forward jobs to other computing nodes as needed.

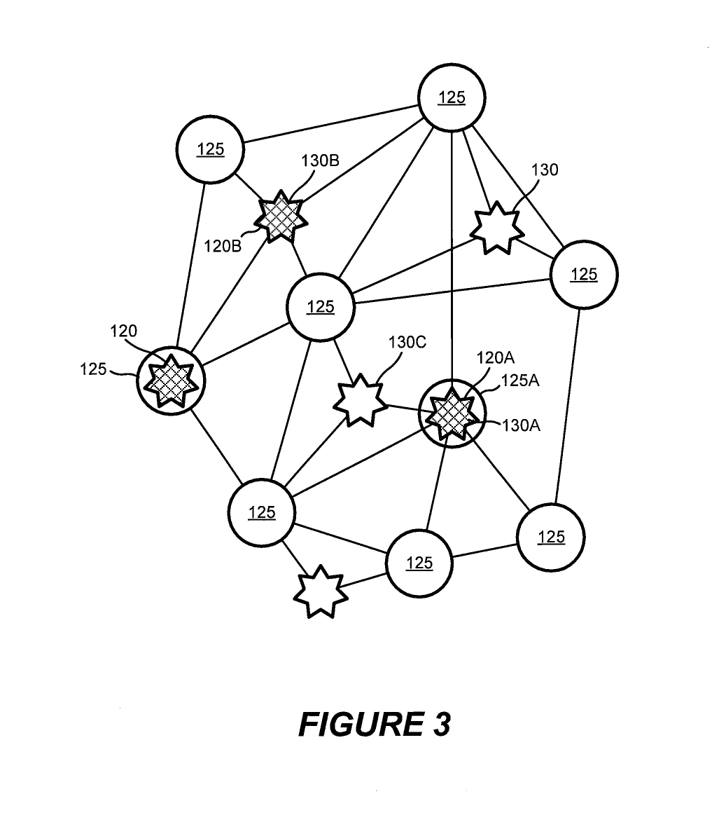

FIG. 3 is a block diagram illustrating a distributed data processing network environment 300 in which agents can be deployed according to embodiments of the inventive concepts. In particular, FIG. 3 illustrates a distributed data processing network environment 300 including a plurality of computing nodes 125 that can execute jobs. FIG. 3 also illustrates a plurality of agent nodes 130 on which agents 120 can be deployed. That is, in the diagram of FIG. 3, circles represent computing nodes 125, and stars represent agent nodes 130 on which agents 120 can be or have been deployed. Shaded stars represent agent nodes 130 on which agents 120 have been deployed, while un-shaded stars represent agent nodes 130 on which agents 120 have not yet been deployed, but could be. As can be seen in FIG. 3, agents and computing nodes can in some cases reside on the same computing node 125.

For example, agent 120A is deployed on computing node 125A which also acts as agent node 130A, while agent 120B is deployed on agent node 130B. Agent node 130C is configured to host an agent, but does not currently host an agent.

Lines between adjacent network nodes, such as computing nodes 125 and agent nodes 130, represent network effective network path lengths between adjacent computing nodes. Other network nodes, such as routers, gateways, or other computing nodes, may be present in network shown in FIG. 3 but are not illustrated for ease of understanding.

Agents 120 are deployed onto agent nodes 130 by the network management server 50 shown in FIG. 1. According to some embodiments, the network management server 50 determines where in the distributed data processing network environment 300 to deploy agents. As described in more detail below, the network management server 50 may choose locations within the distributed data processing network environment 300 at which to deploy agents based on the evaluation of a value function and/or a cost function that may take into account factors, such as the effective network path lengths between agent nodes 130 and computing nodes 125, the number of agents that are being deployed, and/or the actual workloads at the computing nodes 125.

For example, in some embodiments, when the network management server 50 determines that it is necessary to deploy a new agent 120 in the distributed data processing network environment 300, the network management server 50 may select an agent node 130 for deployment of the agent 120 that maximizes a value function. The value function may take into account network path lengths between the agent nodes and the computing nodes and the number of computing jobs to be executed at the computing nodes.

The value function may have the form:

VF=Σ(Wm)(Sma)(Dma) [1]

where Wm is the workload at an mth computing node, Dma is a scale factor that depends on a network path length between the mth computing node and an ath agent node, and Sma is a scale factor indicating that an agent deployed on the ath agent node is executing computing jobs on the mth computing node.

The network path length may be based on an effective path length between the mth computing node and the ath agent node. For example, the network path length may be based on a number of network hops through intervening network forwarding nodes between the mth computing node and the ath agent node and/or a communication latency between the mth computing node and the ath agent node.

The value of Dma may be equal to one if the ath agent node is the agent node closest to the mth computing node based on the network path length between the mth computing node and the ath agent node, and may be equal to zero if the ath agent node is not the agent node closest to the mth computing node based on the network path length between the mth computing node and the ath agent node.

The value of Sma may be equal to one if the ath agent node is executing (or will execute) computing jobs on the mth computing node, and may be equal to zero if the ath agent node is not/will not be executing computing jobs on the mth computing node.

The workload at the mth computing node, Wm, may corresponds to a number of computing jobs to be executed on the mth computing node.

The value of Dma may be equal to an average network path length from all agent nodes to the mth computing node divided by a network path length from the ath agent node to the mth computing node.

According to further embodiments, an agent may be relocated from a first agent node to a second agent node in response to changes in workloads on the computing nodes and network path lengths of the first agent node and the second agent node to the computing nodes.

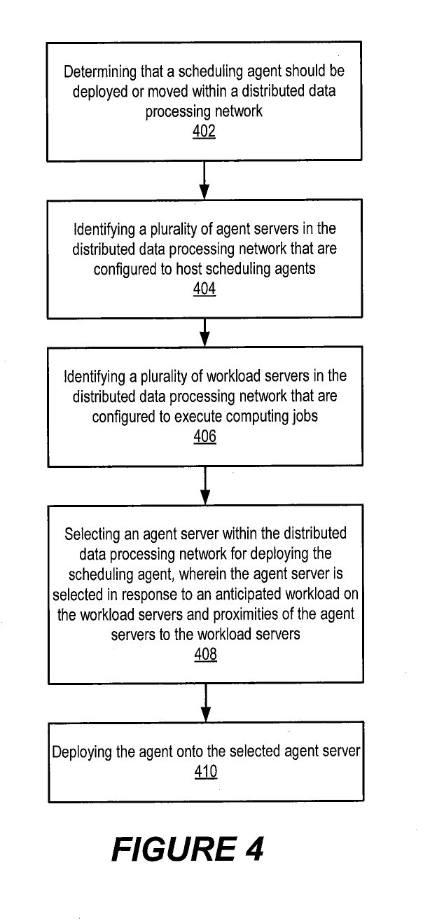

FIG. 4 is a flowchart illustrating operations of systems/methods in accordance with some embodiments of the inventive concepts. Referring to FIG. 4, operations commence when a network management server 50 determines at block 402 that an agent should be deployed onto an agent node (or re-deployed from one agent node to another agent node) in a distributed data processing network. The operations then identify a plurality of network nodes within the distributed data processing network environment that are capable of hosting agents, i.e., that are capable of acting as an agent node (Block 404). Next, the operations then identify one or more computing nodes within the distributed data processing network that are configured to execute computing jobs under the direction and control of the agents (Block 406). The operations may further determine current and/or anticipated workloads of the computing nodes.

The operations then select an agent node within the distributed computing network for deploying the agent based on at least the anticipated workloads on the computing nodes and the network path lengths of the agent nodes to the computing nodes (Block 408). The network path length of an agent node to a computing node may be determined, for example, by an effective path length between the agent node and the computing node.

Once the agent node has been selected, the agent may be deployed onto the agent node (Block 410). An agent may be deployed onto an agent node by, for example, sending an instruction from the network management server 50 to the agent node instructing the agent node to load and initialize a specified agent module in the agent node.

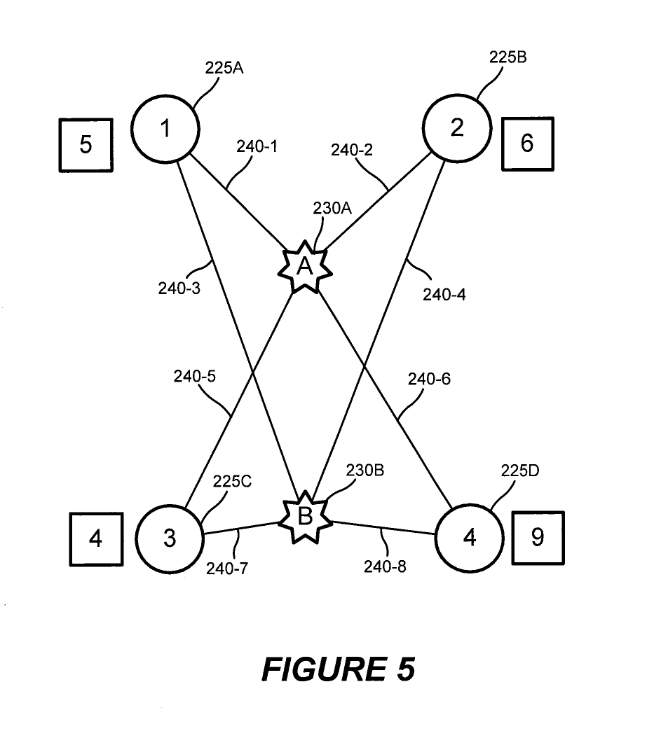

FIG. 5 is a block diagram illustrating an example deployment of an agent according to embodiments of the inventive concepts. In particular, in the example shown in FIG. 5, a network management server 50 is determining whether to deploy an agent onto a first agent node 230A or a second agent node 230B within a distributed computing network 500. The distributed computing network 500 includes four computing nodes 225A to 225D, which are executing the number of jobs illustrated in FIG. 5. In particular, the first computing node 225A will execute five jobs, the second computing node 225B will execute six jobs, the third computing node 225C will execute four jobs, and the fourth computing node 225D will execute nine jobs for the agent.

The agent nodes 230A, 230B and the computing nodes 225A to 225D communicate over communication links 240-1 to 240-8. Effective path lengths of the communication links 240-1 to 240-8 between agent nodes 230A, 230B and the computing nodes 225A to 225D are represented by the lengths of the lines connecting the respective nodes. Accordingly, the first agent node 230A has a shorter network path to the first computing node 225A than it does to the third and fourth computing nodes 225C, 225D.

In some embodiments, the effective path length, Dma, of a communication length between two of the nodes may be set as a latency (or reciprocal latency), or normalized latency (or reciprocal latency), of communications between the mth computing node and the ath agent node. In other embodiments, the value of Dma may be chosen as the bandwidth, or a normalized bandwidth, of the communication link between the mth computing node and the ath agent node. In still other embodiments, the value of Dma may represent the number of network “hops” between two nodes, or the number of intervening nodes in a shortest communication path between two nodes.

According to some embodiments, the network management server 50 may choose to deploy the agent onto whichever of the first agent node 230A or the second agent node 230B maximizes the value function given in Equation [1] above. In this case, for the first agent node 230A, the value function evaluates as follows, assuming that Dma is 1 when the ath agent node is the closest agent node to the mth computing node, and zero otherwise:

VF|ₐ₌₁=Σ(Wm)(Sma)(Dma)=(5)(1)(1)+(6)(1)(1)+(4)(1)(0)+(9)(1)(0)=11

Likewise, for the second agent node 230B, the value function evaluates as follows:

VF|ₐ₌₂=Σ(Wm)(Sma)(Dma)=(5)(1)(0)+(6)(1)(0)(4)(1)(1)(9)(1)(1)=13

Thus, in this example, the network management server 50 will deploy the agent at the second agent node 220B.

As another example, assume that normalized bandwidths of the communication links 240-1 to 240-2 are as shown in the following table:

TABLE 1
Normalized bandwidths of communication links

| Communication | | Agent | |
|---|---|---|---|
| Link | Computing node | node | Normalized Bandwidth |
| 240-1 | 225A | 230A | 0.9 |
| 240-2 | 225B | 230A | 0.8 |
| 240-3 | 225A | 230B | 0.1 |
| 240-4 | 225B | 230B | 0.15 |
| 240-5 | 225C | 230A | 0.3 |
| 240-6 | 225D | 230A | 0.4 |
| 240-7 | 225C | 230B | 1 |
| 240-8 | 225D | 230B | 0.7 |

In this case, the value function evaluates as follows for the first agent node 220A:

VF|ₐ₌₁=Σ(Wm)(Sma)(Dma)=(5)(1)(0.9)(6)(1)(0.8)(4)(1)(0.3)+(9)(1)(0.4)=14.1

Likewise, for the second agent node 230B, the value function evaluates as follows:

VF|ₐ₌₂=Σ(Wm)(Sma)(Dma)=(5)(1)(0.1)+(6)(1)(0.15)+(4)(1)(1)+(9)(1)(0.7)=11.7

In this example, the agent would be deployed at the first agent node 230A.

As noted above, in other embodiments a cost function may be employed, and the agent may be deployed at the agent node that minimizes the cost function.

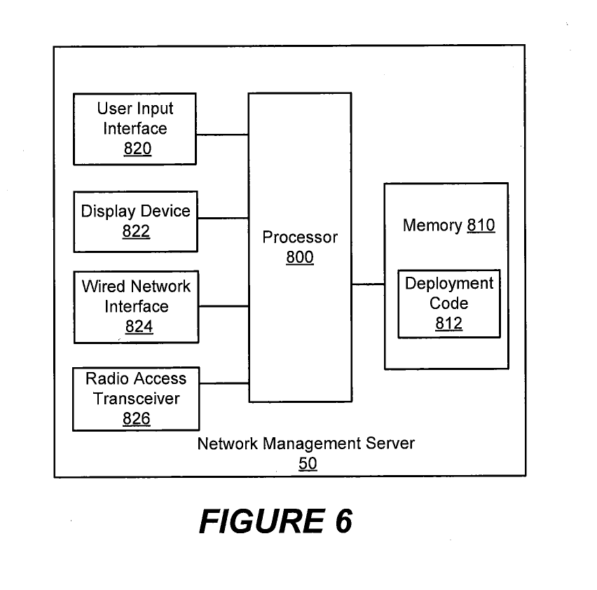

FIG. 6 is a block diagram of a device that can be configured to operate as the network management server 50 according to some embodiments of the inventive concepts. The network management server 50 includes a processor 800, a memory 810, and a network interface which may include a radio access transceiver 826 and/or a wired network interface 824 (e.g., Ethernet interface). The radio access transceiver 826 can include, but is not limited to, a LTE or other cellular transceiver, WLAN transceiver (IEEE 802.11), WiMax transceiver, or other radio communication transceiver via a radio access network.

The processor 800 may include one or more data processing circuits, such as a general purpose and/or special purpose processor (e.g., microprocessor and/or digital signal processor) that may be collocated or distributed across one or more networks. The processor 800 is configured to execute computer program code in the memory 810, described below as a non-transitory computer readable medium, to perform at least some of the operations described herein. The server 50 may further include a user input interface 820 (e.g., touch screen, keyboard, keypad, etc.) and a display device 822.

The memory 810 includes computer readable code that configures the scheduler 100 to implement the job scheduler module 102, the broker module 104, and the data collection module 106. In particular, the memory 810 includes deployment code 812 that configures the network management server 50 to deploy agents according to the methods described above.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit” “module,” “component” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on a computing device;
identifying a plurality of computing nodes in a distributed computing network that are configured to execute computing jobs;
selecting an agent node from among a plurality of agent nodes for deploying an agent within the distributed computing network, wherein the agent controls processing of the computing jobs on at least one of the plurality of computing nodes, and wherein the agent node is selected in response to an anticipated workload on the computing nodes and network path lengths of the agent nodes to the computing nodes; and
deploying the agent onto the selected agent node to control processing of at least one the computing jobs on the plurality of computing nodes.

2. The method of claim 1, wherein selecting the agent node comprises selecting an agent node that maximizes a value function.

3. The method of claim 2, wherein the value function takes into account network path lengths between the agent nodes and the computing nodes and the number of computing jobs to be executed at the computing nodes.

4. The method of claim 2, wherein the value function comprises:
VF=Σ(Wm)(Sma)(Dma)
where Wm is the workload at an mth computing node among the computing nodes, Dma is a scale factor that depends on a network path length between the mth computing node and an ath agent node among the agent nodes, and Sma is a scale factor indicating that an agent deployed on the ath agent node is executing computing jobs on the mth computing node.

5. The method of claim 4, wherein the network path length is based on a number of network hops through intervening network forwarding nodes between the mth computing node and the ath agent node and/or a communication latency between the mth computing node and the ath agent node.

6. The method of claim 5, wherein Dma is equal to one if the ath agent node is the agent node closest to the mth computing node based on the network path length between the mth computing node and the ath agent node, and is equal to zero if the ath agent node is not the agent node closest to the mth computing node based on the network path length between the mth computing node and the ath agent node.

7. The method of claim 4, wherein Sma is equal to one if the ath agent node is executing computing jobs on the mth computing node, and is equal to zero if the ath agent node is not executing computing jobs on the mth computing node.

8. The method of claim 4, wherein the workload at the mth computing node, Wm, corresponds to a number of computing jobs to be executed on the mth computing node.

9. The method of claim 4, wherein Dma is equal to an average network path length from all agent nodes to the mth computing node divided by a network path length from the ath agent node to the mth computing node.

10. The method of claim 1, further comprising:
relocating the agent from the selected agent node to a second agent node in response to changes in workloads on the first and second computing nodes and network path lengths of the selected agent node and the second agent node to the first and second computing nodes.

11. A computer program product, comprising:
a non-transitory computer readable storage medium comprising computer readable program code embodied in the medium that when executed by a processor of a computing device causes the processor to perform operations comprising:
performing operations as follows on a computing device;
identifying a plurality of computing nodes in a distributed computing network that are configured to execute computing jobs;
selecting an agent node from among a plurality of agent nodes for deploying an agent within the distributed computing network, wherein the agent controls processing of at least one of the computing jobs on the plurality of computing nodes, and wherein the agent node is selected in response to an anticipated workload on the computing nodes and network path lengths of the agent nodes to the computing nodes; and
deploying the agent onto the selected agent node to control execution of the at least one of the computing jobs on the plurality of computing nodes.

12. The computer program product of claim 11, wherein selecting the agent nodes comprises selecting an agent node that maximize a value function.

13. The computer program product of claim 12, wherein the value function takes into account network path lengths between the agent nodes and the computing nodes and the number of computing jobs to be executed at the computing nodes.

14. The computer program product of claim 12, wherein the value function comprises:
VF=Σ(Wm)(Sma)(Dma)
where Wm is the workload at an mth computing node among the computing nodes, Dma is a scale factor that depends on a network path length between the mth computing node and an ath agent node among the agent nodes, and Sma is a scale factor indicating that an agent on the ath agent node is executing computing jobs on the mth computing node.

15. The computer program product of claim 14, wherein the network path length is based on a number of network hops through intervening network forwarding nodes between the mth computing node and the ath agent node and/or a communication latency between the mth computing node and the ath agent node.

16. The computer program product of claim 15, wherein Dma is equal to one if the ath agent node is the agent node closest to the mth computing node based on the network path length between the mth computing node and the ath agent node, and is equal to zero if the ath agent node is not the agent node closest to the mth computing node based on the network path length between the mth computing node and the ath agent node.

17. The computer program product of claim 14, wherein Sma is equal to one if the ath agent node is executing computing jobs on the mth computing node, and is equal to zero if the ath agent node is not executing computing jobs on the mth computing node.

18. The computer program product of claim 14, wherein the workload at the mth computing node, Wm, corresponds to a number of computing jobs to be executed on the mth computing node.

19. The computer program product of claim 14, wherein Dma is equal to an average network path length from all agent nodes to the mth computing node divided by a network path length from the ath agent node to the mth computing node.

20. The computer program product of claim 11, further comprising computer readable program code embodied in the medium that when executed by a processor of a computing device causes the processor to perform operations comprising:
relocating the agent from the selected agent node to a second agent node in response to changes in workloads on the first and second computing nodes and network path lengths of the selected agent node and the second agent node to the first and second computing nodes.
